(19) United States
(12) Patent Application Publication
(10) Pub. No.: US 2025/0292368 A1
(43) Pub. Date: Sep. 18, 2025

(54) SYSTEMS AND METHODS FOR IMAGE COMPOSITING VIA MACHINE LEARNING

(71) Applicant: YAHOO ASSETS LLC, New York, NY (US)

(72) Inventors: Bhavin JAWADE, Buffalo, NY (US); Amir ERFAN ESHRATIFAR, Buffalo, NY (US); Kapil THADANI, New York, NY (US); Paloma DE JUAN, New York, NY (US); Joao Vitor Baldini SOARES, New York, NY (US); Jack CULPEPPER, New York, NY (US)

(21) Appl. No.: 19/072,081

(22) Filed: Mar. 6, 2025

Related U.S. Application Data
(60) Provisional application No. 63/565,155, filed on Mar. 14, 2024.

(51) Int. Cl. G06T 5/50; G06T 5/60; G06T 11/60

(52) U.S. Cl. CPC G06T 5/50; G06T 5/60; G06T 11/60; G06T 2207/20081; G06T 2207/20084; G06T 2207/20221

(57) ABSTRACT

In some implementations, the techniques described herein relate to a method including: identifying, by a processor, a digital image file that includes a background scene and an additional digital image file that includes a foreground object; compositing, by a machine learning model executed by the processor, the digital image file and the additional digital image file to produce a composite digital image file that includes the foreground object placed in front of the background scene by: identifying a location within the background scene in the digital image file for placement of the foreground object from the additional digital image file; transforming at least one aspect of the foreground object to harmonize with the background scene; and creating a composite image file that includes the harmonized foreground object in the location within the background scene; causing display, by the processor, of the composite image file.

### CROSS REFERENCE TO RELATED APPLICATIONS

This application claims the benefit of U.S. Provisional Patent Application No. 63/565,155 filed Mar. 14, 2024, the contents of which is hereby incorporated by reference.

### BACKGROUND

Various types of machine learning models are able to generate images. Users can easily generate images of different styles and subject matter based on text and/or image prompts. However, compositing images—that is, placing one or more objects from a first image into a background from a second image—remains a highly challenging problem. Different images may have different lighting conditions, perspectives, scales, depths of field, visual styles, color balances, and so on. The smallest detail out of place can easily reveal to a viewer that something is amiss. Compositing images by hand can be a tedious and time-consuming process, making automation in this field a useful innovation.

### BRIEF DESCRIPTION OF THE DRAWINGS

FIG. 1 is a block diagram illustrating a system for image compositing via machine learning according to some of the example embodiments.

FIG. 2 is a flow diagram illustrating a method for image compositing via machine learning according to some of the example embodiments.

FIG. 3 is a block diagram illustrating a method for image compositing via machine learning according to some of the example embodiments.

FIG. 4 is a block diagram of a computing device according to some embodiments of the disclosure.

### DETAILED DESCRIPTION

The instant disclosure describes systems and methods for programmatically compositing multiple images via machine learning models. Various machine learning (ML) models are capable of generating and/or editing images. One example of such a model is a generative ML model. Generative ML models, often underpinned by Generative Adversarial Networks (GANs) or diffusion models as well as text-based transformer models, are trained on massive datasets of images and text prompts and can be used to generate images of various sizes and styles in response to text and/or image-based prompts. Generative ML models are typically composed of a neural network with many parameters (typically billions of weights or more). For example, a generative ML model may use a GAN to analyze training data and/or image inputs. In some implementations, a generative ML model may use multiple neural networks working in conjunction. In one implementation, a generative ML model may also be capable of editing images. Additionally, or alternatively, a different type of ML model may be trained to edit images (e.g., images generated by a GAN-based model) by compositing two or more images together.

The example embodiments herein describe methods, computer-readable media, device, and systems that create composite images from one or more foreground objects and a background scene via one or more ML models. In some implementations, the systems described herein may train an ML model to perform image compositing and/or create training data for an ML model.

In some aspects, the techniques described herein relate to a method including: identifying, by a processor, a digital image file that includes a background scene and an additional digital image file that includes a foreground object; compositing, by a machine learning model executed by the processor, the digital image file that includes the background scene and the additional digital image file that includes the foreground object to produce a composite digital image file that includes the foreground object placed in front of the background scene by: identifying a location within the background scene in the digital image file for placement of the foreground object from the additional digital image file; transforming at least one aspect of the foreground object to harmonize with the background scene; and creating a composite image file that includes the harmonized foreground object in the location within the background scene; causing display, by the processor, of the composite image file that includes the harmonized foreground object in the location within the background scene.

In some aspects, the techniques described herein relate to a method, wherein identifying, by the processor, the digital image file and the additional digital image file includes receiving text instructions describing at least one of the foreground object and the background scene.

In some aspects, the techniques described herein relate to a method, further including generating, by the machine learning model, at least one of the digital image file and the additional digital image file in response to receiving the text instructions.

In some aspects, the techniques described herein relate to a method, wherein the machine learning model includes a multi-module architecture wherein a first module encodes the background scene and the foreground object and identifies the location and a second module predicts the at least one aspect of the foreground object to be transformed.

In some aspects, the techniques described herein relate to a method, wherein the second module generates a greyscale image of the same dimensionality of the composite image file to be blended with the composite image file with a learnable alpha.

In some aspects, the techniques described herein relate to a method, wherein creating the composite image file includes combining the foreground object, the background scene, and the greyscale image.

In some aspects, the techniques described herein relate to a method, wherein creating the composite image file includes training for the machine learning model by backpropagating a weighted combination of pixel wise cross-entropy loss, pixel wise L2 loss, and L2 loss between a set of original foreground object coordinates and the location of the foreground object in the composite image.

In some aspects, the techniques described herein relate to a method, wherein creating the composite image file includes training for the machine learning model by backpropagating a weighted combination of pixel wise cross-entropy loss, pixel wise L1 loss, and L1 loss between a set of original foreground object coordinates and the location of the foreground object in the composite image.

In some aspects, the techniques described herein relate to a method, wherein creating the composite image file includes applying at least one transformation to the background scene.

In some aspects, the techniques described herein relate to a non-transitory computer-readable storage medium for tangibly storing computer program instructions capable of being executed by a computer processor, the computer program instructions defining steps of: identifying, by a processor, a digital image file that includes a background scene and an additional digital image file that includes a foreground object; compositing, by a machine learning model executed by the processor, the digital image file that includes the background scene and the additional digital image file that includes the foreground object to produce a composite digital image file that includes the foreground object placed in front of the background scene by: identifying a location within the background scene in the digital image file for placement of the foreground object from the additional digital image file; transforming at least one aspect of the foreground object to harmonize with the background scene; and creating a composite image file that includes the harmonized foreground object in the location within the background scene; causing display, by the processor, of the composite image file that includes the harmonized foreground object in the location within the background scene.

In some aspects, the techniques described herein relate to a non-transitory computer-readable storage medium, wherein identifying, by the processor, the digital image file and the additional digital image file includes receiving text instructions describing at least one of the foreground object and the background scene.

In some aspects, the techniques described herein relate to a non-transitory computer-readable storage medium, further including generating, by the machine learning model, at least one of the digital image file and the additional digital image file in response to receiving the text instructions.

In some aspects, the techniques described herein relate to a non-transitory computer-readable storage medium, wherein the machine learning model includes a multi-module architecture wherein a first module encodes the background scene and the foreground object and identifies the location and a second module predicts the at least one aspect of the foreground object to be transformed.

In some aspects, the techniques described herein relate to a non-transitory computer-readable storage medium, wherein the second module generates a greyscale image of the same dimensionality of the composite image file to be blended with the composite image file with a learnable alpha.

In some aspects, the techniques described herein relate to a non-transitory computer-readable storage medium, wherein creating the composite image file includes combining the foreground object, the background scene, and the greyscale image.

In some aspects, the techniques described herein relate to a non-transitory computer-readable storage medium, wherein creating the composite image file includes training for the machine learning model by backpropagating a weighted combination of pixel wise cross-entropy loss, pixel wise L2 loss, and L2 loss between a set of original foreground object coordinates and the location of the foreground object in the composite image.

In some aspects, the techniques described herein relate to a non-transitory computer-readable storage medium, wherein creating the composite image file includes training for the machine learning model by backpropagating a weighted combination of pixel wise cross-entropy loss, pixel wise L1 loss, and L1 loss between a set of original foreground object coordinates and the location of the foreground object in the composite image.

In some aspects, the techniques described herein relate to a non-transitory computer-readable storage medium, wherein creating the composite image file includes applying at least one transformation to the background scene.

In some aspects, the techniques described herein relate to a device including: a processor; and a storage medium for tangibly storing thereon logic for execution by the processor, the logic including instructions for: identifying, by the processor, a digital image file that includes a background scene and an additional digital image file that includes a foreground object; compositing, by a machine learning model executed by the processor, the digital image file that includes the background scene and the additional digital image file that includes the foreground object to produce a composite digital image file that includes the foreground object placed in front of the background scene by: identifying a location within the background scene in the digital image file for placement of the foreground object from the additional digital image file; transforming at least one aspect of the foreground object to harmonize with the background scene; and creating a composite image file that includes the harmonized foreground object in the location within the background scene; causing display, by the processor, of the composite image file that includes the harmonized foreground object in the location within the background scene.

In some aspects, the techniques described herein relate to a device, wherein identifying, by the processor, the digital image file and the additional digital image file includes receiving text instructions describing at least one of the foreground object and the background scene.

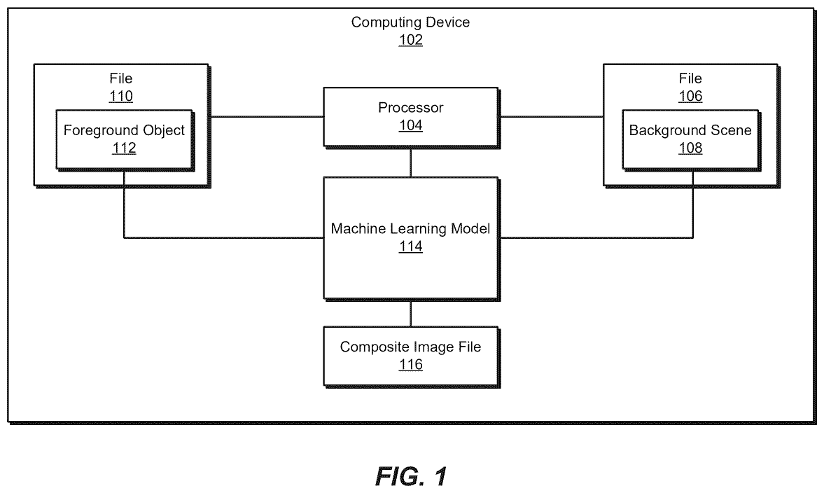

FIG. 1 is a block diagram illustrating a system for image compositing via machine learning according to some of the example embodiments.

The illustrated system includes a computing device 102. Computing device 102 may be configured with a processor 104 that identifies a file 106 that includes a background scene 108 and a file 110 that includes a foreground object 112. Processor 104 may execute an ML model 114 to composite file 106 and file 110 by identifying a location within background scene 108 for placement of foreground object 112, transforming at least one aspect of the foreground object 112 to harmonize with background scene 108, and creating a composite image file 116 that includes harmonized foreground object 112 in the location within background scene 108. In some examples, processor 104 may cause display of composite image file 116.

Although illustrated here on a single computing device 102, any or all of the systems described herein may be hosted by one or more servers and/or cloud-based processing resources. Additionally, or alternatively, any or all of the systems herein may be hosted on one or more client devices (e.g., endpoint devices such as laptops, desktops, smart devices, etc.). Further details of these components are described herein and in the following flow diagrams.

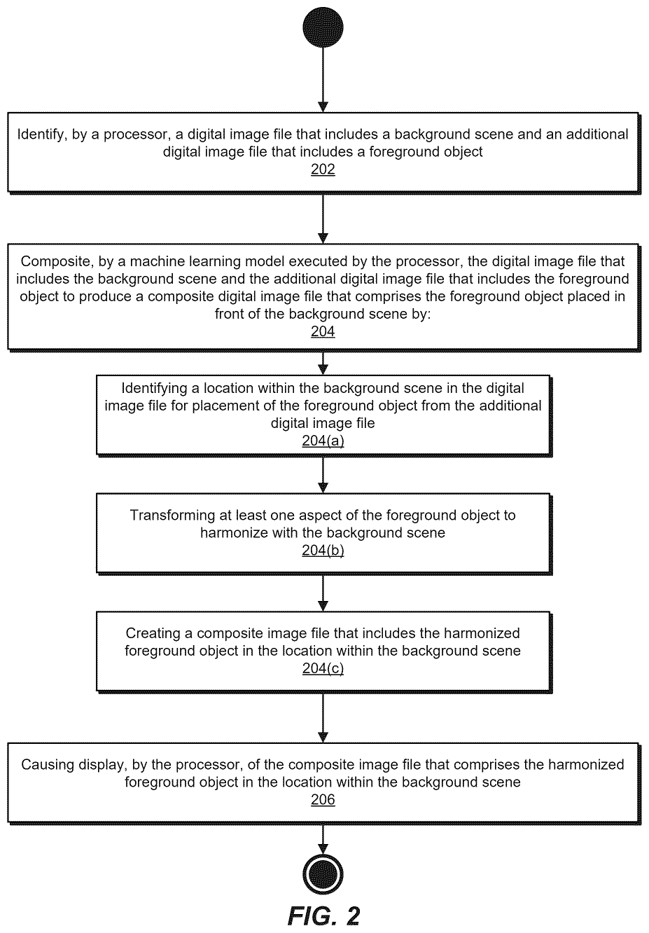

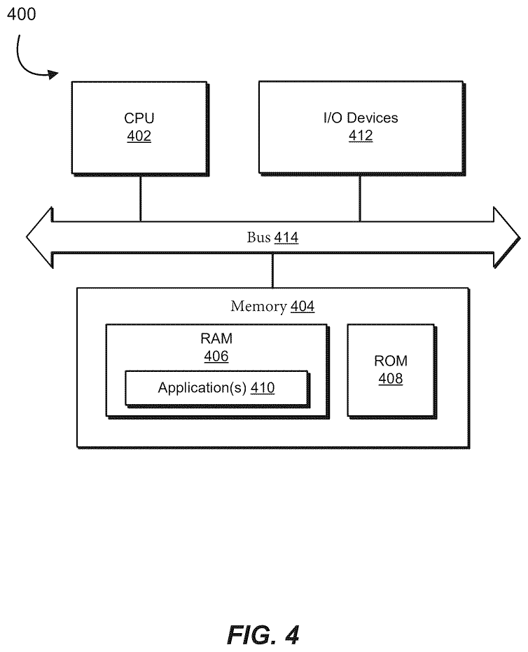

In the various implementations, computing device 102, processor 104, and/or ML model 114 can be implemented using various types of computing devices such as laptop/desktop devices, mobile devices, server computing devices, etc. Specific details of the components of such computer devices are provided in the description of FIG. 4 which are not repeated herein. In general, these devices can include a processor and a storage medium for tangibly storing thereon logic for execution by the processor. In some implementations, the logic can be stored on a non-transitory computer readable storage medium for tangibly storing computer program instructions. In some implementations, these instructions can implement some of all of the method described in FIG. 2.

In some implementations, files 106 and/or 110 can include digital image files of any type, size, and/or format. In one example, files 106 and/or 110 may be images generated by a generative ML model. Additionally, or alternatively, files 106 and/or 110 may be other types of images, such as photographs, digital paintings, vector images, and so forth. In some examples, file 106 and file 110 may be files of different origins and/or file types. For example, file 106 may be a photograph stored in MPEG format while file 110 may be a generated image stored in PNG format.

In one implementation, ML model 114 may include a GAN and/or other type of neural network. In some implementations, ML model 114 may include a diffusion-based ML model. In one implementation, ML model 114 may include a network of connected ML models. For example, ML model 114 may include an image encoding model and an image refinement model.

FIG. 2 is a flow diagram illustrating a method for image compositing via ML according to some of the example embodiments.

In step 202, the method can include identifying, by a processor, a digital image file that includes a background scene and an additional digital image file that comprises a foreground object.

In step 204, the method can include compositing, by a machine learning model executed by the processor, the digital image file that includes the background scene and the additional digital image file that includes the foreground object to produce a composite digital image file that comprises the foreground object placed in front of the background scene.

In step 204(a), the method can include identifying a location within the background scene in the digital image file for placement of the foreground object from the additional digital image file.

The systems described herein may identify the location in a variety of ways. In some examples, the systems described herein may identify a location based on a text prompt, such as “put the dog in front of the house” or “put the toaster on the counter to the right of the microwave.” Additionally, or alternatively, the systems described herein may receive coordinates of the location (e.g., pixel grid coordinates). In some examples, the systems described herein may identify a location programmatically (e.g., by identifying a location where the foreground object will have high contrast against the background scene).

In step 204(b), the method can include transforming at least one aspect of the foreground object to harmonize with the background scene.

The systems described herein may transform a variety of different aspects of the object. For example, the systems described herein may scale the object, change the perspective of the object, change the lighting conditions of the object, alter the color palette of the object, change the shadows cast on and/or by the object, increase or decrease the brightness and/or contrast of the object, crop the object, duplicate the object, and/or perform any other suitable transformation.

In step 204(c), the method can include creating a composite image file that includes the harmonized foreground object in the location within the background scene.

The systems described herein may create the composite image file in a variety of ways. For example, the systems described herein may match the dimensions of the image file that includes the background scene. In some implementations, the systems described herein may paste the foreground object into the background scene at the location. In some examples, the systems described herein may perform one or more transformations on the background scene. For example, the systems described herein may add and/or remove shadows to the background scene to harmonize with the new foreground object, adjust the lighting conditions, and/or perform other suitable transformations.

In step 206, the method can include causing display, by the processor, of the composite image file that includes the harmonized foreground object in the location within the background scene.

The systems described herein can cause the display of the composite image in a variety of ways. In one implementation, the systems described herein may be configured on a personal computing device and may display the image on a screen of the computing device. In another implementation, the systems described herein may be configured on a server and may transmit the image to an endpoint computing device for display. Additionally, or alternatively, the systems described herein may store the image to be used as training data for one or more ML models.

In some implementations, the ML model may be trained on training data where each training data example consists of triplets containing the input background image, the input foreground object image or cutout, and the desired composite output image. As mentioned above, an optional additional input may be the label or text describing the class of changes allowed when doing compositing. This training data may be generated in multiple ways.

One way of generating training data is to use a model to learn the appearance of any particular foreground object (given one or more images of the object) and then to use either a text-prompt-based image editing technique or alternatively inpainting in order to place the object in the given background image. A single image of the foreground object could then be chosen randomly when forming the training triplets.

In this approach, given an object and a background image, the parameters that define the object placement and harmonization will be predicted by two trained models. To train these models, the systems described herein may take as input a dataset of triplets of the following form: object, background, and composite image. In one implementation, the systems described herein may create this dataset programmatically by obtaining segmented objects, performing shadow removal and/or inpainting, and applying augmentations for harmonization.

In one implementation, the systems described herein may perform steps of detecting and segmenting multiple objects within an image. One approach is to use an off-the-shelf segmentation model. Another approach is to make use of pre-annotated datasets that include manual semantic segmentations. Once the systems described herein have the segmentation masks, the systems described herein may choose one of the segments and store it as the object that is to be placed during training. The segmentation masks will also allow the systems described herein to remove (via inpainting) different objects from the image.

After the objects are detected and segmented, the next step involves inpainting the image. Inpainting is a process where missing (or selected) parts of an image are filled in. In this case, the systems described herein may use inpainting to fill in the regions where the object was removed, creating a seamless appearance. In some implementations, the systems described herein may perform the process of random inpainting at multiple locations within the image to prevent the model from overfitting to specific inpainting artifacts that correspond to the object of interest.

To further enhance the dataset for harmonization tasks, the systems described herein may apply a series of augmentations on the object image. These augmentations are transformations that modify the appearance of objects in various ways. Examples of augmentations may include perspective transforms (changing the viewing angle), rescaling (altering the size), image colorization (adjusting colors), solarization (inverting the colors), and potentially other techniques tailored to the detected objects. These augmentations help diversify the training data and prepare the model for a wider range of scenarios. The augmentations may also help the model learn harmonization, since the model will have to learn to undo any changes in color that were applied as part of the augmentations.

The systems described herein may be configured with architecture to train end-to-end localization and harmonization networks that involves a multi-module architecture where the first module encodes the background image and the cropped object and finds the right coordinates to place the object. Then a refinement block (e.g., a harmonization block) predicts image processing manipulations (e.g., contrast, brightness, perspective transforms, etc.) to be applied over the object and also generates shadow images. In some embodiments, shadow images may grayscale images of the same dimensionality as the input image that will be blended with the input images with a learnable alpha. Additionally or alternatively, the systems described herein may generate full color shadow images. In some examples, the shadow image may be used for changes such as specularities and/or reflections. The refinement block may take as input the encoded background image, cropped object, as well as the predicted coordinates. Finally, the systems described herein may stitch the processed object at the proposed coordinates onto the inpainted image with the blended shadow.

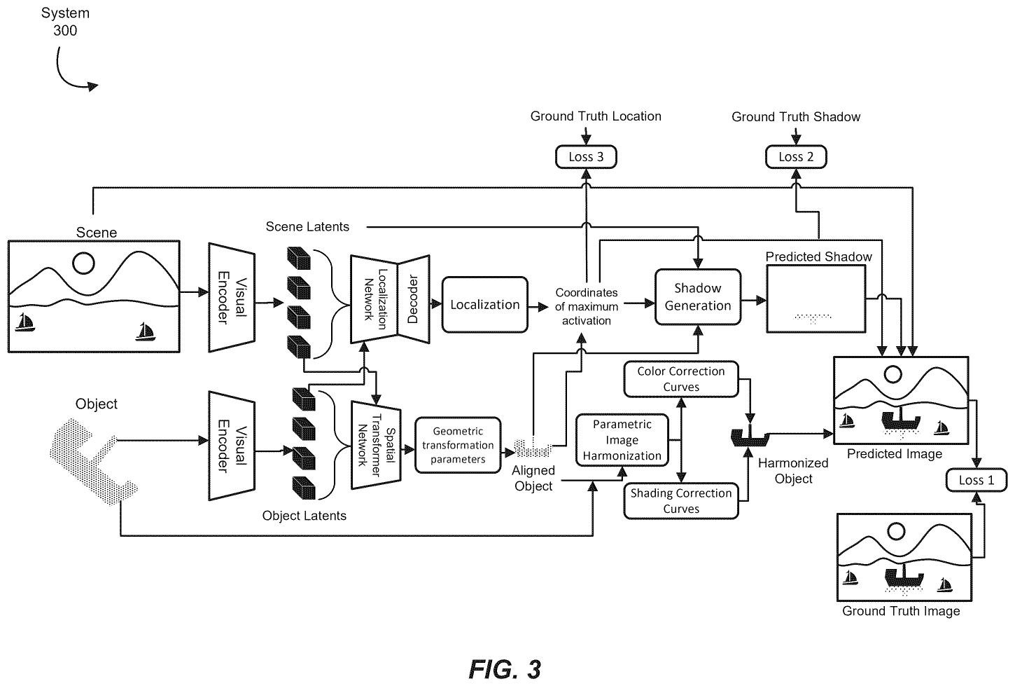

In some embodiments, the systems described herein may include a system with multiple modules that each perform various transformations on the foreground object and/or background scene. For example, system 300 illustrated in FIG. 3, performs four key tasks towards compositing: localization, alignment, harmonization and shadow generation. The first part of the network encodes the background image and the cropped object and then finds the right coordinates to place the object. System 300 may predict a geometric alignment grid for the object conditioned on the scene and object features. In some embodiments, this can be performed using a spatial transformer or similar network. The aligned image is then passed through a harmonization block. Parallelly, a generative model (e.g., a GAN, a diffusion model, etc.) is employed to predict the shadow image conditioned on the scene features, predicted location and the object features. Finally, the harmonized image, predicted shadow and the scene image are stitched together to get the predicted image. Since a majority of the image is unchanged, in some embodiments system 300 may compute pixel-wise cross-entropy loss over the ROI between the predicted image and ground truth image. In some examples, system 300 may compute a loss between the predicted shadow image and the original shadow image.

In some embodiments, to perform parametric image alignment, system 300 may utilize a spatial transformer network that is conditioned on both the object image and the scene image. This network is responsible for manipulating the object image by performing affine transformations such as translation, rotation, and scaling to achieve proper alignment within the scene image. In one embodiment, to perform potential placement region localization, system 300 may identify potential placement regions within the scene image where the object can be naturally integrated. The localization network, along with a decoder, maps out these regions, ensuring that the object is inserted into a part of the scene that is contextually suitable for its size, shape, and orientation.

To perform parametric harmonization, system 300 may predict parametric non-linear polynomial curves for both color and shading correction. These curves are applied to the object image to achieve color and luminance harmonization, ensuring that the object's appearance is consistent with the lighting and color palette of the scene image. In some examples, to perform shadow prediction, system 300 may generate a shadow for the object image based on the identified coordinates of maximum activation within the scene and conditioned on the scene image features and object features. In some embodiments, system 300 may utilize image-to-image generation models including, without limitation, U-Nets, GANs or diffusion models.

During training, the systems described herein may backpropagate a weighted combination of pixel wise cross-entropy loss, pixel wise L2 loss, and a L2 loss between the original object coordinates and the predicted object location to update the model weights. Additionally, or alternatively, the systems described herein may backpropagate pixel wise L1 loss and/or L1 loss. These losses together may ensure that the object is blended well with the image, shadow pixels are estimated accurately, and the location of the object is close to the ground truth location. This process may help train both the image placement module and the harmonization module in a single network.

In some implementations, the systems described herein may perform other types of image editing and/or generation tasks. For example, the systems described herein may include a generative ML model that can automatically expand the background of images (e.g., so that the images fit different aspect ratios well). For example, the backgrounds could be staged environments or simple color gradients or patterns. In some implementations, the model may constrain the generation as to not generate any extra foreground objects. In some examples, the systems described herein may use an image that is expanded in this way as a background scene for image compositing. In some examples, the systems described herein may provide edited images to an editorial tool used by content creators.

The systems described herein may use objects that have been segmented from images in various ways in addition to as training data for one or more ML models. For example, the systems described herein may include a creative animation framework that generates templated animations with composable/exchangeable elements. This framework may take segmented images and add new backgrounds of different sizes or aspect ratios. In one implementation, the framework may also accept text input to display alongside the generated animation.

FIG. 4 is a block diagram of a computing device according to some embodiments of the disclosure.

As illustrated, the device 400 includes a processor or central processing unit (CPU) such as CPU 402 in communication with a memory 404 via a bus 414. The device also includes one or more input/output (I/O) or peripheral devices 412. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 402 may comprise a general-purpose CPU. The CPU 402 may comprise a single-core or multiple-core CPU. The CPU 402 may comprise a system-on-a-chip (SoC) or a similar embedded system. In some embodiments, a graphics processing unit (GPU) may be used in place of, or in combination with, a CPU 402. Memory 404 may comprise a memory system including a dynamic random-access memory (DRAM), static random-access memory (SRAM), Flash (e.g., NAND Flash), or combinations thereof. In one embodiment, the bus 414 may comprise a Peripheral Component Interconnect Express (PCIe) bus. In some embodiments, the bus 414 may comprise multiple busses instead of a single bus.

Memory 404 illustrates an example of a non-transitory computer storage media for the storage of information such as computer-readable instructions, data structures, program modules, or other data. Memory 404 can store a basic input/output system (BIOS) in read-only memory (ROM), such as ROM 408 for controlling the low-level operation of the device. The memory can also store an operating system in random-access memory (RAM) for controlling the operation of the device.

Applications 410 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 406 by CPU 402. CPU 402 may then read the software or data from RAM 406, process them, and store them in RAM 406 again.

The device may optionally communicate with a base station (not shown) or directly with another computing device. One or more network interfaces in peripheral devices 412 are sometimes referred to as a transceiver, transceiving device, or network interface card (NIC).

An audio interface in peripheral devices 412 produces and receives audio signals such as the sound of a human voice. For example, an audio interface may be coupled to a speaker and microphone (not shown) to enable telecommunication with others or generate an audio acknowledgment for some action. Displays in peripheral devices 412 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 412 may comprise any input device arranged to receive input from a user. An illuminator in peripheral devices 412 may provide a status indication or provide light. The device can also comprise an input/output interface in peripheral devices 412 for communication with external devices, using communication technologies, such as USB, infrared, Bluetooth®, or the like. A haptic interface in peripheral devices 412 provides tactile feedback to a user of the client device.

A GPS receiver in peripheral devices 412 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 4, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
identifying, by a processor, a digital image file that comprises a background scene and an additional digital image file that comprises a foreground object;
compositing, by a machine learning model executed by the processor, the digital image file that comprises the background scene and the additional digital image file that comprises the foreground object to produce a composite digital image file that comprises the foreground object placed in front of the background scene by:
identifying a location within the background scene in the digital image file for placement of the foreground object from the additional digital image file;
transforming at least one aspect of the foreground object to harmonize with the background scene; and
creating a composite image file that comprises the harmonized foreground object in the location within the background scene;
causing display, by the processor, of the composite image file that comprises the harmonized foreground object in the location within the background scene.

2. The method of claim 1, wherein identifying, by the processor, the digital image file and the additional digital image file comprises receiving text instructions describing at least one of the foreground object and the background scene.

3. The method of claim 2, further comprising generating, by the machine learning model, at least one of the digital image file and the additional digital image file in response to receiving the text instructions.

4. The method of claim 1, wherein the machine learning model comprises a multi-module architecture wherein a first module encodes the background scene and the foreground object and identifies the location and a second module predicts the at least one aspect of the foreground object to be transformed.

5. The method of claim 4, wherein the second module generates a greyscale image of the same dimensionality of the composite image file to be blended with the composite image file with a learnable alpha.

6. The method of claim 5, wherein creating the composite image file comprises combining the foreground object, the background scene, and the greyscale image.

7. The method of claim 1, wherein creating the composite image file comprises training for the machine learning model by backpropagating a weighted combination of pixel wise cross-entropy loss, pixel wise L2 loss, and L2 loss between a set of original foreground object coordinates and the location of the foreground object in the composite image.

8. The method of claim 1, wherein creating the composite image file comprises training for the machine learning model by backpropagating a weighted combination of pixel wise cross-entropy loss, pixel wise L1 loss, and L1 loss between a set of original foreground object coordinates and the location of the foreground object in the composite image.

9. The method of claim 1, wherein creating the composite image file comprises applying at least one transformation to the background scene.

10. A non-transitory computer-readable storage medium for tangibly storing computer program instructions capable of being executed by a computer processor, the computer program instructions defining steps of:
identifying, by a processor, a digital image file that comprises a background scene and an additional digital image file that comprises a foreground object;
compositing, by a machine learning model executed by the processor, the digital image file that comprises the background scene and the additional digital image file that comprises the foreground object to produce a composite digital image file that comprises the foreground object placed in front of the background scene by:
identifying a location within the background scene in the digital image file for placement of the foreground object from the additional digital image file;
transforming at least one aspect of the foreground object to harmonize with the background scene; and
creating a composite image file that comprises the harmonized foreground object in the location within the background scene;
causing display, by the processor, of the composite image file that comprises the harmonized foreground object in the location within the background scene.

11. The non-transitory computer-readable storage medium of claim 10, wherein identifying, by the processor, the digital image file and the additional digital image file comprises receiving text instructions describing at least one of the foreground object and the background scene.

12. The non-transitory computer-readable storage medium of claim 11, further comprising generating, by the machine learning model, at least one of the digital image file and the additional digital image file in response to receiving the text instructions.

13. The non-transitory computer-readable storage medium of claim 10, wherein the machine learning model comprises a multi-module architecture wherein a first module encodes the background scene and the foreground object and identifies the location and a second module predicts the at least one aspect of the foreground object to be transformed.

14. The non-transitory computer-readable storage medium of claim 13, wherein the second module generates a greyscale image of the same dimensionality of the composite image file to be blended with the composite image file with a learnable alpha.

15. The non-transitory computer-readable storage medium of claim 14, wherein creating the composite image file comprises combining the foreground object, the background scene, and the greyscale image.

16. The non-transitory computer-readable storage medium of claim 10, wherein creating the composite image file comprises training for the machine learning model by backpropagating a weighted combination of pixel wise cross-entropy loss, pixel wise L2 loss, and L2 loss between a set of original foreground object coordinates and the location of the foreground object in the composite image.

17. The non-transitory computer-readable storage medium of claim 10, wherein creating the composite image file comprises training for the machine learning model by backpropagating a weighted combination of pixel wise cross-entropy loss, pixel wise L1 loss, and L1 loss between a set of original foreground object coordinates and the location of the foreground object in the composite image.

18. The non-transitory computer-readable storage medium of claim 10, wherein creating the composite image file comprises applying at least one transformation to the background scene.

19. A device comprising:
a processor; and
a storage medium for tangibly storing thereon logic for execution by the processor, the logic comprising instructions for:
identifying, by the processor, a digital image file that comprises a background scene and an additional digital image file that comprises a foreground object;
compositing, by a machine learning model executed by the processor, the digital image file that comprises the background scene and the additional digital image file that comprises the foreground object to produce a composite digital image file that comprises the foreground object placed in front of the background scene by:
identifying a location within the background scene in the digital image file for placement of the foreground object from the additional digital image file;
transforming at least one aspect of the foreground object to harmonize with the background scene; and
creating a composite image file that comprises the harmonized foreground object in the location within the background scene;
causing display, by the processor, of the composite image file that comprises the harmonized foreground object in the location within the background scene.

20. The device of claim 10, wherein identifying, by the processor, the digital image file and the additional digital image file comprises receiving text instructions describing at least one of the foreground object and the background scene.
